(19) United States
(12) Patent Application Publication
(10) Pub. No.: US 2009/0309943 A1
(43) Pub. Date: Dec. 17, 2009

(54) INK CARTRIDGE CARRIER

(75) Inventors: HSUANG-YANG LIN, Tu-Cheng (TW); WAN-LONG FU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/274,328

(22) Filed: Nov. 19, 2008

(30) Foreign Application Priority Data
Jun. 13, 2008 (CN) 200810302139.6

(51) Int. Cl. B41J 29/13

(52) U.S. Cl. 347/108; 347/86

(57) ABSTRACT

An ink cartridge carrier for mounting an ink cartridge that includes a flange includes a backplane, a cradle fixed to the backplane and configured for receiving the ink cartridge, and a cover rotatably mounted to the backplane. The cover includes a top board, and a slide way extending from the top board for the flange to be slid along and supported thereupon. One of the cradle and the cover includes a clasp, the other one of the cradle and the cover includes a clipping portion defining a clipping hole. The clasp is capable of being clipped into the clipping hole.

### BACKGROUND

1. Technical Field

The disclosure relates to ink cartridge carriers and, more particularly, to an ink cartridge carrier of an inkjet printing apparatus.

2. Description of Related Art

In an inkjet printing apparatus, a carrier is used to mount an ink cartridge. An ordinary carrier is usually assembled from a great number of parts, and most of the parts are made via injection molding. Thus, a large number of molds are needed, which is costly and assembly-and-operation complex and difficult.

### BRIEF DESCRIPTION OF THE DRAWINGS

FIG. 1 is an assembled, isometric view of an ink cartridge carrier and two ink cartridges, wherein the carrier includes a backplane, a cradle, and a cover.

FIG. 2 is a disassembled view of FIG. 1.

FIG. 3 is an assembled, isometric view of the backplane and the cradle of FIG 1.

FIG. 4 shows the carrier of FIG. 1 in a free state.

### DETAILED DESCRIPTION

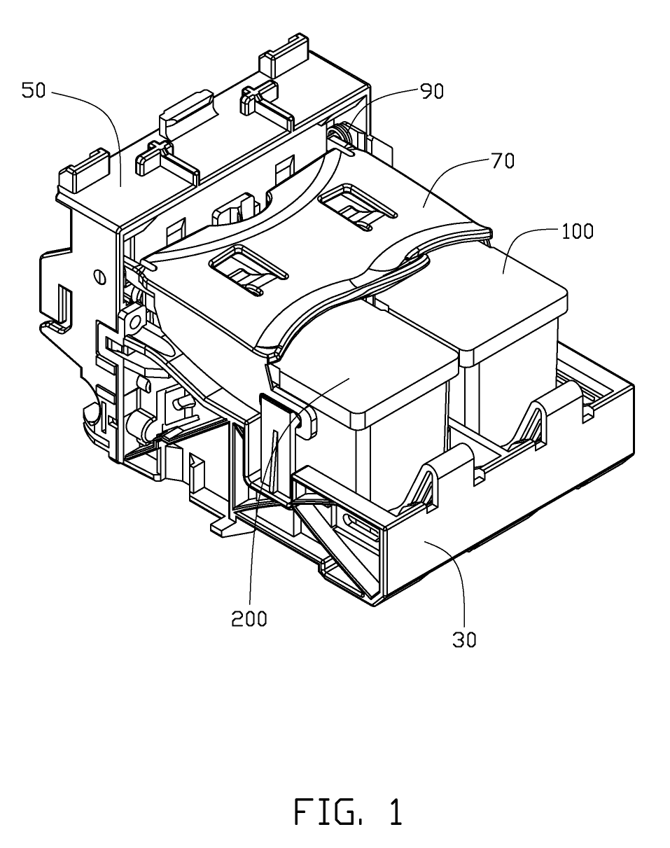

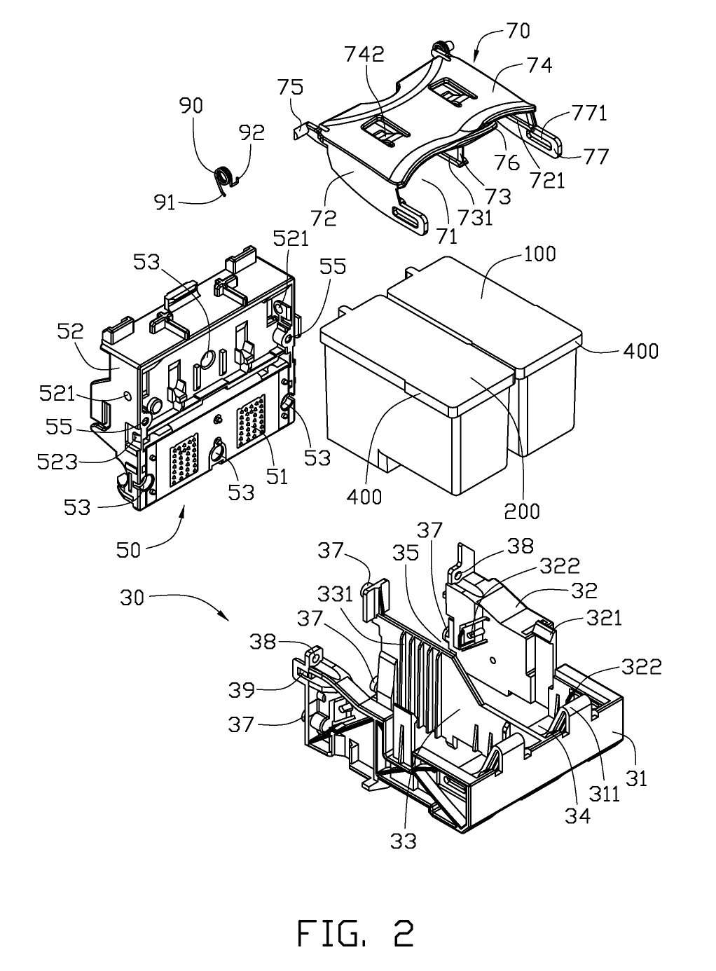

Referring to FIGS. 1 and 2, an exemplary embodiment of an ink cartridge carrier is provided for mounting two ink cartridges 100 and 200. Each of the ink cartridges 100 and 200 includes an electrical interface (not shown) at a rear end. A flange 400 extends from edges of a top of each of the ink cartridges 100 and 200. The carrier includes a backplane 50, a cradle 30, and a cover 70.

Two flexible printed circuit boards 51 are attached to the backplane 50, for electrically connecting to the electrical interfaces of the ink cartridges 100 and 200, respectively. A plurality of locating holes 53 and two fixing holes 55 are defined in the backplane 50. Two opposite sidewalls 52 extend from the backplane 50. Two coaxial pivot holes 521 are defined in the sidewalls 52. A projection 523 extends from each sidewall 52.

The cradle 30 includes a base board 34, a front board 31 perpendicularly extending upward from a front end of the base board 34, two side boards 32 perpendicularly extending upward from opposite sides of the base board 34, and a middle board 33 perpendicularly extending upward from the base board 34 between and parallel to the side boards 32. The middle board 33 partitions the cradle 30 into two receiving units 35, for accommodating lower portions of the corresponding ink cartridges 100 and 200.

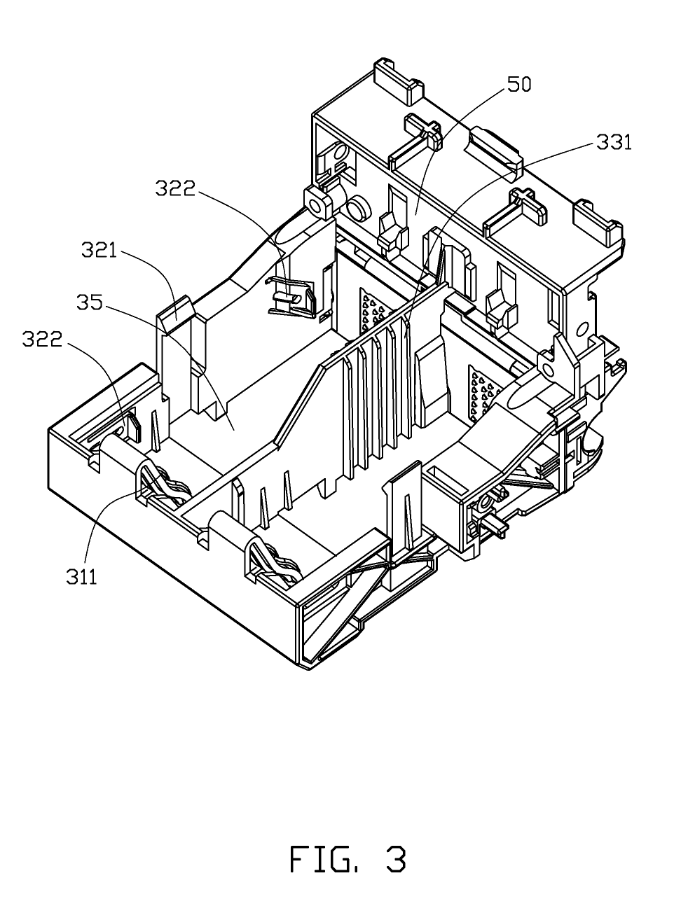

Referring to FIG. 3, the front board 31 includes two elastic members 311 extending into the receiving units 35 respectively. In one embodiment, each elastic member 311 is an upside down V-shaped elastic piece extending from a top of the front board 31.

Each side board 32 includes two elastic members 322 extending in the corresponding receiving unit 35, wherein one of the elastic members 322 is adjacent to a rear end of the side board 32 and the other one is adjacent to the front board 31. In one embodiment, two holes (not labeled) are defined in each side board 32, and each elastic member 322 is an L-shaped elastic piece extending from a wall bounding one of the holes. A clasp 321 extends upward from each side board 32. An extending piece (not labeled) extends upward from the rear end of each side board 32. A fixing hole 38 corresponding to one of the fixing holes 55 of the backplane 50 is defined in each extending piece. A mounting piece (not labeled) extends backward from the rear end of each side board 32. A clipping hole 39 corresponding to one of the projections 523 of the backplane 50 is defined in each mounting piece.

The middle board 33 includes a plurality of raised strips 331 extending from opposite side surfaces of the middle board 33 and perpendicular to the base board 34. A height of each raised strip 331 extending from the middle board 33 into the corresponding receiving unit 35 gradually increases from a top of the middle board 33 to a bottom of the middle board 33.

A plurality of locating projections 37 extends from a rear end of the middle board 33 and rear ends of the side boards 32, corresponding to the locating holes 53 of the backplane 50.

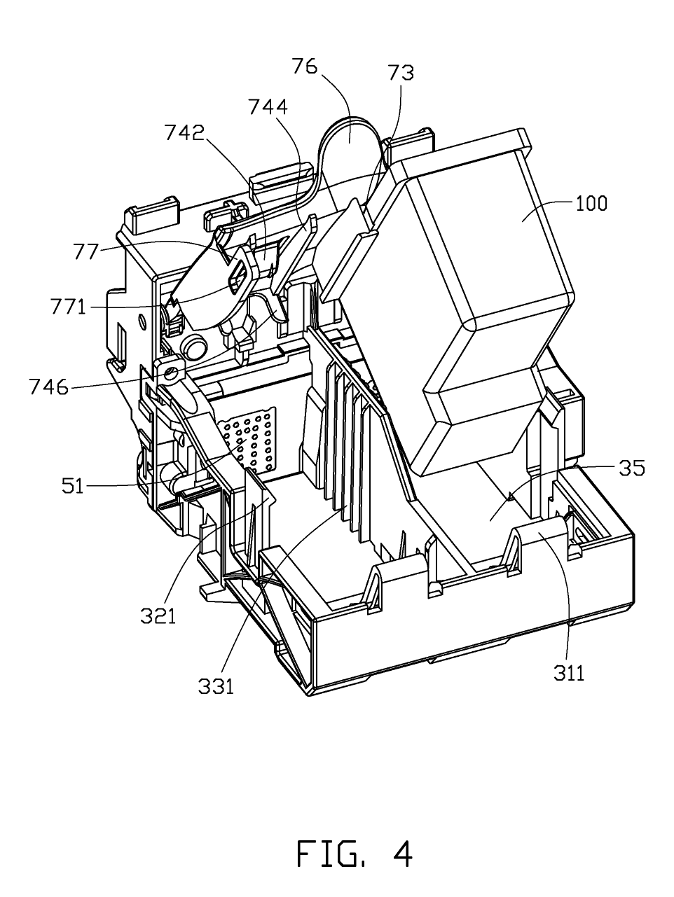

Referring to FIGS. 2 and 4, the cover 70 includes a top board 74, two ears 72 extending downward from opposite ends of the top board 74, respectively. An inner bar 73 extends downward from the top board 74 between and parallel to the ears 72. The inner bar 73 partitions the cover 70 into two installing units 71, for accommodating upper portions of the corresponding ink cartridges 100 and 200. Two pivoting shafts 75 extend from a rear side of the top board 74 corresponding to the two pivoting holes 521 of the backplane 50. A handle portion 76 extends from a front side of the top board 74.

A clipping portion 77 defining a clipping hole 771 extends from each ear 72, away from the corresponding pivoting shaft 75 and corresponding to one of the clasps 321 of the cradle 30. A first slide rail 721 extends inward from each ear 72. A second slide rail 731 extends toward each ear 72 from the inner bar 73. The second slide rail 731 and the corresponding first slide rail 721 cooperatively form a slide way for the flange 400 of the ink cartridge 100 or 200 to be slid along and supported on.

In each installing unit 71, two raised strips 744 parallel to the ears 72 perpendicularly extend down from the top board 74; an n-shaped blocking piece 746 extends down from the rear side of the top board 74 perpendicular to the raised strips 744; and an elastic member 742 extends down from the top board 74, between the raised strips 744. In one embodiment, two holes (not labeled) are defined in the top board 74, and each elastic member 742 is a tongue-shaped elastic piece extending from a wall bounding one of the holes.

In assembly, the locating projections 37 of the cradle 30 are inserted into the corresponding locating holes 53 of the backplane 50. Two screws (not shown) are inserted through the fixing holes 38 and inserted into the corresponding fixing holes 55 to fix the cradle 30 and the backplane 50 together. An elastic member, such as a torsion spring 90, fits about each pivoting shaft 75 of the cover 70. The pivoting shafts 75 are inserted into the corresponding pivoting holes 521 of the backplane 50. Each torsion spring 90 includes a first foot 91 and a second foot 92, wherein the first foot 91 engages with the backplane 50 and the second foot 92 engages with the cover 70. The torsion springs 90 are configured to bias the cover 70 to be opened up when the carrier is in a free state. In other embodiments, other elastic members may be used to instead of the torsion springs 90, such as V-shaped elastic pieces or pressure springs engaged between the backplane 50 and the cover 70.

In use, the ink cartridge 100 is operated as an example (see FIG. 4). In assembling the cartridge 100, the cover 70 is opened up from the cradle 30, the ink cartridge 100 is slid into the corresponding installing unit 71 of the cover 70, with the flange 400 supported on and moving along the first slide rail 721 and the second slide rail 731. The raised strips 744 abut against the top of the ink cartridge 100. The elastic member 742 is deformed and abuts against the top of the ink cartridge 100. The cover 70 is rotated down toward the cradle 30, until the clasps 321 are clipped into the corresponding clipping holes 771. Thus, the ink cartridge 100 is received in the corresponding receiving unit 35 of the cradle 50. Here, the corresponding raised strips 331 are set to fit the outline of the ink cartridge 100. The corresponding elastic members 322 bias the ink cartridge 100 to abut against the corresponding raised strips 331, so as to firmly sandwich the ink cartridge 100 together with the corresponding raised strips 331. The corresponding elastic member 311 biases a front end of the ink cartridge 100, thereby making the electrical interface at the rear end of the ink cartridge 100 to be pressingly connected with the corresponding flexible printed circuit board 51 of the backplane 50.

In disassembling the ink cartridge 100, the handle portion 76 is operated. The clipping portions 77 and the clasps 321 are deformed a little and then disengaged from each other. Thus, the cover 70 can be rotated up, and the ink cartridge 100 is ready to be pulled out of the cover 70.

In other embodiments, the positions of the clipping portions 77 of the cover 70 and the clasps 321 of the cradle 30 may be interchanged to achieve same functions.

In other embodiments, the elastic members 322 may be formed from the middle board 33, while the raised strips 331 may be formed from the side boards 32, to achieve same functions.

It is to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. An ink cartridge carrier for mounting two ink cartridges each comprising a flange, the carrier comprising:
a backplane;
a cradle fixed to the backplane and configured for receiving the ink cartridges; and
a cover rotatably mounted to the backplane and comprising a top board, and two slide ways extending from the top board for the flanges to be slid along and supported thereupon;
wherein one of the cradle and the cover comprises at least one clasp, the other one of the cradle and the cover comprises at least one clipping portion defining a clipping hole, the at least one clasp is capable of being clipped into the at least one clipping hole.

2. The carrier of claim 1, wherein the cover further comprises two ears extending downward from opposite ends of the top board, and an inner bar extending down from the top board between and parallel to the ears; wherein an installing unit is formed between each of the ears and the inner bar, configured for accommodating a corresponding ink cartridge.

3. The carrier of claim 2, wherein a first slide rail extends inward from each of the ears, two second slide rails extend from the inner bar into the two installing units, each of the first slide rails and the corresponding second slide rail cooperatively form one of the two slide ways.

4. The carrier of claim 3, wherein the at least one clipping portion comprises two clipping portions extending from the ears respectively; the at least one clasp comprises two clasps extending from the cradle.

5. The carrier of claim 4, wherein the cradle comprises the two clasps, and further comprises a base board, a front board extending up from a front end of the base board, and two side boards extending up from opposite sides of the base board, the two clasps extend from the two side boards respectively.

6. The carrier of claim 5, wherein the cradle further comprises a middle board extending up from the base board between and parallel to the side boards, the middle board partitions the cradle into two receiving units, configured for accommodating the corresponding ink cartridges.

7. The carrier of claim 6, wherein an elastic member extends from the top board into each of the installing units, configured for elastically resisting against a top of the corresponding ink cartridge.

8. The carrier of claim 7, wherein the top board defines two holes, each of the elastic members is a tongue-shaped elastic piece extending from a wall bounding one of the holes.

9. The carrier of claim 6, wherein an elastic member extends from the front board into each of the installing units, configured for elastically resisting against a front end of the corresponding ink cartridge.

10. The carrier of claim 9, wherein each of the elastic members is a upside down V-shaped elastic piece extending inward from a top of the front board.

11. The carrier of claim 6, wherein an elastic member extends from each of the side boards, configured for elastically resisting against a first side of the corresponding ink cartridge; and a plurality of raised strips extending from each of two side surfaces of the middle board for abutting against a second side opposite to the first side of the corresponding ink cartridge.

12. The carrier of claim 11, wherein each of the side boards defines a hole, each of the elastic members is an L-shaped elastic piece extending from a wall bounding the corresponding hole.

13. The carrier of claim 1, further comprising an elastic member engaged between the backplane and the cover, for biasing the cover to keep open.

14. The carrier of claim 13, wherein two pivoting shafts extend from a rear side of the top board, two pivoting holes are defined in the backplane, the pivoting shafts engaging in the pivoting holes, respectively, for rotatably attaching the cover to the backplane, the elastic member comprises two torsion springs, each of the torsion springs fits about one of the pivoting shaft and engages with the backplane and the cover via two feet of the torsion spring.

15. An ink cartridge carrier for mounting an ink cartridge that comprises a flange, the carrier comprising:
a backplane;
a cradle fixed to the backplane and configured for receiving the ink cartridge; and
a cover rotatably mounted to the backplane and comprising a top board, wherein a slide way extends from the top board for the flange to be slid along and supported on;
wherein one of the cradle and the cover comprises a clasp, the other one of the cradle and the cover comprises a clipping portion defining a clipping hole, the clasp is capable of being clipped into the clipping hole.

16. The carrier of claim 15, wherein the cover comprises first and second side boards extending downward from the top board, a first slide rail extends inward form the first side board, a second slide rail extends inward from the second side board, the first slide rail and the second slide rail cooperatively form the slide way.

17. The carrier of claim 16, wherein the cradle comprises a base board, a front board extending from a front end of the base board, and third and fourth side boards extending up from the base board and perpendicular to the front board, the clasp extends from the third side board, the clipping portion extends from the first board.

18. The carrier of claim 17, wherein an elastic member extends from the front board, configured for elastically resisting against a front end of the ink cartridge.

19. The carrier of claim 17, an elastic member extends from the third side board, configured for elastically resisting against a first side of the ink cartridge, a plurality of raised strips extending from the fourth board for abutting against a second side opposite to the first side of the ink cartridge.

20. The carrier of claim 15, wherein an elastic member extends from the top board, configured for elastically resisting against a top of the ink cartridge.
